(19) United States
(12) Patent Application Publication
(10) Pub. No.: US 2012/0145248 A1
(43) Pub. Date: Jun. 14, 2012

(54) METHOD AND APPARATUS TO INDICATE ACTIVATION OF PRESSURE RELIEF DEVICE

(75) Inventors: Hans-Joachim Huff, Mainz (DE); Jason Scarcella, Cicero, NY (US); Lucy Yi Liu, Fayetteville, NY (US); Suresh Duraisamy, Liverpool, NY (US); Zvonko Asprovski, Liverpool, NY (US); Mark S. Rogers, Hastings, NY (US); Gilbert B. Hofsdal, Chittenango, NY (US)

(73) Assignee: CARRIER CORPORATION, Farmington, CT (US)

(21) Appl. No.: 13/390,377

(22) PCT Filed: Aug. 24, 2010
(86) PCT No.: PCT/US2010/046484

§ 371 Date: Feb. 14, 2012

Related U.S. Application Data
(60) Provisional application No. 61/236,749, filed on Aug. 25, 2009.
(60) Provisional application No. 61/237,097, filed on Aug. 26, 2009.

(51) Int. Cl. F16K 37/00

(52) U.S. Cl. 137/1; 137/557

(57) ABSTRACT

An activation indicator for a refrigeration system pressure relief valve is presented. In one embodiment, the indicator comprises a covering that covers an outlet passage of the pressure relief valve. The covering is at least partially displaceable by refrigerant as it exits the refrigeration system through the pressure relief valve. In another embodiment, sensors outputting a signal transmit an altered signal when the relief device releases refrigerant. A notification device is activated to indicate that the pressure relief device has activated.

### CROSS REFERENCE TO RELATED APPLICATIONS

This application claims priority from, and incorporates by reference the entirety of, U.S. Provisional Patent Application Ser. No. 61/236,749, filed Aug. 25, 2009, and U.S. Provisional Patent Application Ser. No. 61/237,097, filed Aug. 26, 2009.

### BACKGROUND OF THE INVENTION

A basic refrigeration system comprises four components: a compressor, a refrigerant heat rejection heat exchanger, an expansion valve, and an evaporator. In the compressor, a refrigerant gas is compressed. Through the compression, the gas is heated. The heated gas flows through the refrigerant heat rejection heat exchanger, or gas cooler, which may be comprised of coils outside the refrigerated space. The coils provide a large surface area by which heat from the refrigerant is released to the air outside the refrigerated space. As heat is transferred from the refrigerant to the air, the refrigerant cools. The cooled refrigerant is then forced through an expansion valve, which has such a small opening that the refrigerant is transformed into a cold, fast-moving mist, evaporating as it travels through the evaporator, which is comprised of coils in the refrigerated space. As the cold mist evaporates, the refrigerant draws heat from the refrigerated space, thereby cooling the refrigerated space. The refrigerant passes out of the refrigerated space to the compressor, where the cycle starts again.

Refrigeration systems are closed systems that utilize pressure to operate. It is conceivable that undesirably or overly high pressures can develop, which affects the efficiency of the refrigeration system. Overly high pressures can also increase the risk of damage, as well as pose safety hazards, when pressures tax the structural integrity of system materials and construction.

As a pressure regulatory device, refrigeration systems are often equipped with one or more pressure relief valves to help prevent pressure from building too high. These valves are often piped to the compressor to relieve pressure by releasing pressurized refrigerant contained therein. Some refrigeration systems have pressure relief valves piped to a receiver, which acts as a reservoir for refrigerant.

Pressure relief valves can be single-use valves, which open to relieve pressure, and do not close afterward. Or they can be re-sealable valves, which open to relieve pressure, and then close to allow continued operation of the refrigeration system. Continuing operation of the refrigeration system is important, especially when the activation of a pressure relief valve might go unnoticed for some period of time, or when a repair is necessary but cannot be completed immediately.

Re-sealable valves, which are usually a spring-loaded type, are designed to release refrigerant from the refrigeration system when pressure in the system reaches or exceeds a predetermined level of high pressure. As the refrigerant is released, the pressure in the component of the refrigeration system to which the valve is piped is lowered. When the pressure lowers below the predetermined level, the spring-loaded valve is designed to close. For instance, a spring-loaded pressure relief valve has a seal, often an elastomere O-ring, that is forced to a sealed position by a spring. In the sealed position, the spring force presses a valve head against a valve seat, with the seal there between. As the pressure acting on the seal and valve head in the system becomes greater than the sum of the pressure exerted by the spring plus the pressure of the external atmosphere, the pressure inside the system depresses the spring, moving a valve head to press a seal to an open position, thereby creating an outlet for refrigerant inside the system. As the refrigerant exits and the pressure inside the system subsides to a level less than the sum of the external atmospheric pressure plus the spring force, then the spring is supposed to return to its full length and the pressure relief valve is supposed to reseal the refrigeration system.

Unfortunately, the re-sealable pressure relief valves often do not properly re-seal, meaning the seals do not properly re-seat to form tight seals. While the initial seating in one of these valves might satisfactorily seal the refrigeration system, multiple factors cause the seals to improperly seat during re-sealing, including but not limited to misalignment of the O-ring, microscopic fractures of the O-ring, and oil or debris collecting on the sealing surfaces. As a consequence of improper re-sealing, the refrigeration system continues to operate with an undetected leak, which causes an increasing loss of refrigerant and a decrease in operating efficiency.

### SUMMARY OF THE INVENTION

An apparatus and a method are presented to indicate when a pressure relief valve has been activated. In one embodiment, the pressure relief valve activation indicator includes a covering disposed over at least a portion of a pressure relief valve outlet passage. At least a portion of the covering is displaceable by refrigerant flowing out the outlet passage so that the displacement of the covering indicates that the refrigerant has flowed out the outlet passage.

In another embodiment, a method of indicating the activation of a pressure relief valve is provided. The method includes covering at least a portion of an outlet passage of a pressure relief valve with a covering and then displacing at least a portion of the covering with a refrigerant flowing out the outlet passage.

In another embodiment, the pressure relief valve activation indicator includes a pressure relief valve with at least one outlet passage, a sensor, and a notification device in electromagnetic communication with the sensor.

In another embodiment, the method of indicating the activation of a pressure relief valve includes providing a pressure relief valve, attaching a sensor in signal communication with a notification device to a component of the pressure relief valve, activating the pressure relief valve, altering a signal transmitted by the sensor, and activating the notification device.

### BRIEF DESCRIPTION OF THE DRAWINGS

For a further understanding of the invention, reference will be made to the following detailed description of the invention which is to be read in connection with the accompanying drawings, where:

FIG. 1 is a sectioned side view illustrating a prior art re-sealable pressure relief valve, in which the valve is spring loaded and in a sealed position.

FIG. 2 is a sectioned side view illustrating the prior art relief valve of FIG. 1 in an open position.

FIG. 3 is a sectioned side view illustrating an alternate prior art relief valve.

FIG. 4 is a schematic side view of an unactivated, re-sealable pressure relief valve with an activation indicator, according to one embodiment of the invention;

FIG. 5 is a schematic side view of the re-sealable pressure relief valve and activation indicator of FIG. 4, after activation;

FIG. 6 is a schematic side view of a re-sealable pressure relief valve with an activation indicator, according to one embodiment of the invention;

FIG. 7 is a schematic side view of the re-sealable pressure relief valve and activation indicator of FIG. 6, after activation.

FIG. 8 is a schematic side view of a re-sealable pressure relief valve with an activation indicator, according to one embodiment of the invention;

FIG. 9 is a schematic side view of the re-sealable pressure relief valve and activation indicator of FIG. 8, after activation;

FIG. 10 is a sectioned side view illustrating an electrical relief valve activation indicator, according to one embodiment of the invention using an electrical contact;

FIG. 11 is a sectioned side view illustrating an electrical relief valve activation indicator, according to an alternate embodiment of the invention using a strain gauge; and

FIG. 12 is a sectioned side view illustrating an electrical relief valve activation indicator, according to an alternate embodiment of the invention using a pressure sensor.

### DETAILED DESCRIPTION OF THE INVENTION

An indicator is presented to indicate when a pressure relief valve has been activated (i.e. set off to release refrigerant). The indicator works with existing pressure relief valves, including, but not limited to the one depicted in FIGS. 1-3. While the particular valves of FIGS. 1-3 are exemplified herein in order to describe the indicator, one skilled in the art will recognize that the indicator can be used or modified in obvious ways to be used with various other pressure relief valves.

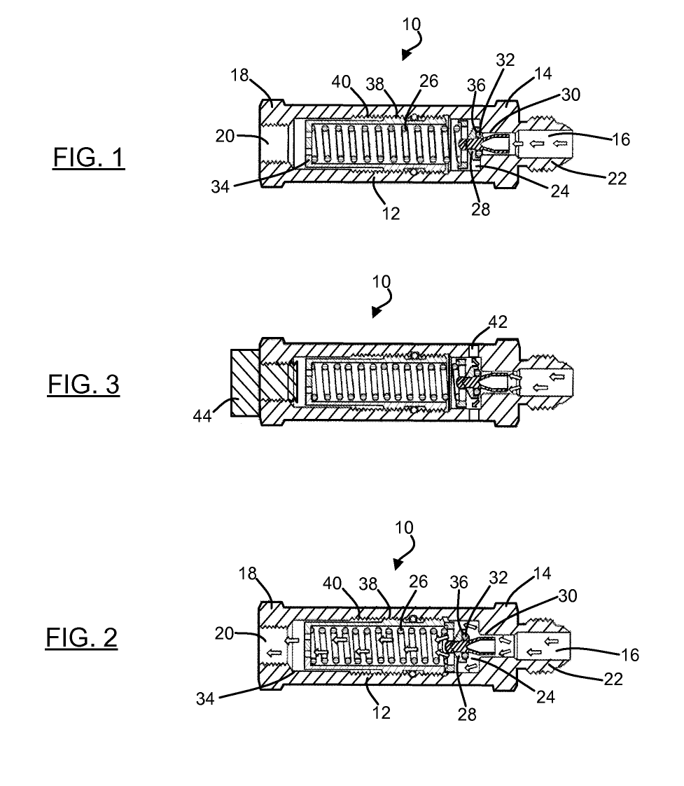

FIGS. 1 and 2 illustrate a typical prior art spring-loaded pressure relief valve. The valve 10 includes an elongated valve body 12 having an inlet end 14 and an outlet end 18, and defining a chamber 24. Inlet end 14 has an externally threaded portion 22 for connecting the valve 10 to a refrigerant system directly or indirectly. The threaded portion 22 at the inlet end 14 defines an inlet passage 16. The outlet end 18 has a rear outlet passage 20 in flow communication with the chamber 24.

In the chamber 24 at the inlet end 14, a valve head 28 has an annular groove 36. An O-ring seal 32 fits into and is held in place by the groove 36. A coiled spring 26 attaches to the valve head 28 on the opposite side from the groove 36. The spring 26 extends through the chamber 18 toward the outlet end 18. The spring 26 is compressed between a collar 34 at the outlet end and the valve head 28. In the sealed position depicted in FIG. 1, the spring 26 presses the valve head 28 and the O-ring seal 32 against a valve seat 30 to seal the inlet passage 16 from the chamber 24. The valve seat 30 is an internal circumference portion of the valve body 12, which encircles the inlet passage 16. The compression of the spring 26 and the force required to overcome the seal can be adjusted by screwing the collar 34. External threads 38 on the collar 34 engage internal threads 40 on the valve body 12, enabling the collar to be screwed closer to the inlet end 14 or closer to the outlet end 18.

In operation, when a pressurized refrigerant passes through the inlet passage 16, it exerts a pressure on the valve head 28 and the O-ring seal 32 in opposition to the force exerted by the spring 26. When the force of the refrigerant exerted on the valve head 28 and the O-ring 32 is below the biasing force of spring 26, the O-ring 32 engages the valve seat 34, so that the relief valve remains closed as shown in FIG. 1. When the force of the refrigerant exceeds the biasing force of the spring 26, the O-ring 32 unseats, and the O-ring 32 and the valve head 28 move toward the outlet end 18 from the inlet passage 16, as seen in FIG. 2. Opening flow communication from the inlet passage 16 to the chamber 24 relieves refrigerant pressure by allowing some of the refrigerant to exit the refrigeration system from the inlet passage 16, through the chamber 24, and out the rear outlet passage 20.

FIG. 3 illustrates an alternate embodiment of the pressure relief valve, in which the refrigerant is vented through one or more side outlet passages 42 located on the side of the valve body 12. A plug 44 can be screwed into the outlet end 18 to close and seal the rear outlet passage 20, and to increase the force of refrigerant exiting through the side outlet passages 42.

In conjunction with the pressure relief valves illustrated in FIGS. 1-3, FIGS. 4-9 illustrate mechanical embodiments of an activation indicator. Referring first to FIGS. 1 and 2, a covering 52, which can be described in this example as a sleeve, a cap, or a boot, covers a portion of the outlet end 18, including the outlet passage 20. The covering 52 has an impact surface 54 that faces the rear outlet passage 20. From the impact surface 54, a sleeve 56 extends around the exterior periphery of the valve body 12 toward the inlet end 16. The sleeve 56 needs only to be long enough to stabilize the impact surface 54 in place over the rear outlet passage 20, so that refrigerant exiting through the rear outlet passage 20 will apply a force on the impact surface 54 to displace the covering 52. However, a longer sleeve 56 will provide greater stability. Alternatively, the covering 52 can be a sleeveless cap, or a patch adhered to the end face circumscribing the rear outlet passage 20. In another alternative, the covering 52 can be a gel, a grease, or another viscous fluid filling the rear outlet passage 20.

When the covering 52 is displaced, it can be blown off the pressure relief valve 10 completely, as depicted in FIG. 5, or it can be moved a distance on the relief valve 10. The displacement of the covering 52 indicates that the relief valve 10 has been set off. In order to make it more easily discernible that the covering 52 has been displaced when the covering 52 is not blown completely off the relief valve 10, a marker can be used. The marker can be a marking 58 on the valve body 12, positioned just under the edge of the end of the sleeve 56 so that when the covering 52 is displaced, the marking is revealed. Otherwise, it can be located along or near the edge of the sleeve 56, in sight, so that the distance between the marking and the edge of the sleeve 56 will be easily discernible after displacement of the covering 52.

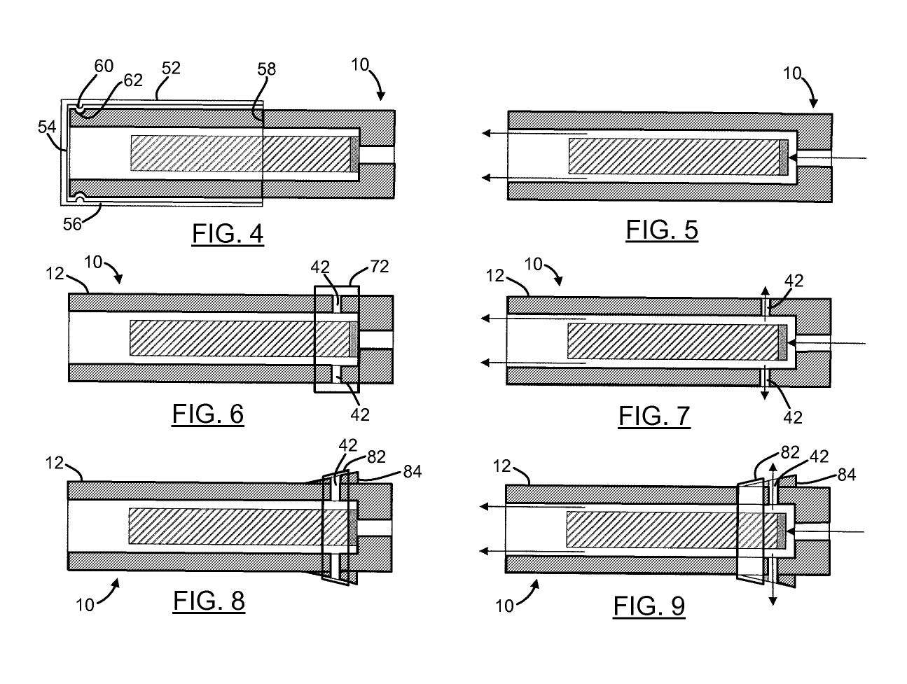

So that the covering 52 will be displaced when refrigerant is released through the relief valve 10, the covering 52 does not fit too tightly. The covering is held in place too tightly if the force exerted to remove the covering 52 does not exceed the force holding the covering 52 in place. On the other hand, the covering 52 is secured strongly enough to prevent it from being displaced accidentally. In order to prevent the covering 52 from being displaced accidentally, a temporary securing mechanism is employed on an internal surface of the sleeve 56. The securing mechanism may include, but not be limited to, a lip, a nudge, or another protrusion. The securing mechanism 60 illustrated in FIG. 4 is a protrusion having an interference fit around the external surface of the valve body 12, in order to hold the covering 52 in place until refrigerant is released through the rear outlet passage 20. Placing the protrusion 60 closer to, rather than farther from the impact surface 54 provides greater structural support for the protrusion 60 to maintain a frictional force. It also requires a shorter distance for the protrusion 60 to travel.

Alternatively, the securing mechanism can semi-permanently attach at least a portion of the covering 52 to the pressure relief valve 10. For instance, between the securing mechanism 60 and the impact surface 54, the covering 52 can be perforated, or otherwise loosely connected to the rest of the covering 52, so that the securing mechanism 60 will secure its portion of the sleeve 56 in place, and allow the portion of the covering 52 containing the impact surface to tear or pull apart. The perforation can be placed on the impact surface 54 so that only a portion of the impact surface tears off. Also, the securing mechanism 60 can be positioned farther from the impact surface to provide more area to put the perforation.

When using such a securing mechanism, its securing force should be stronger than the pressure pushing against it from within the pressure relief valve 10. An adhesive, screw, bolt, latch, or another known fastening mechanism can be used in addition to the previously mentioned lip, nudge, or other protrusion. The securing mechanism 60 can still be removable by tool or hand, but not by activation of the pressure relief valve. Being removable by tool or hand enables the removal and replacement of the pressure relief valve activation indicator.

Alternatively, a material can be used, that easily tears under the force of the exiting refrigerant, without perforations. Paper, thin/weak fabrics, thin plastics, and thin rubbers are examples. A tear or other damage to the covering is a displacement that will indicate refrigerant has exited the refrigeration system through the pressure relief valve 10.

The protrusion can alternatively be placed in the valve body 12 of the relief valve 10. Furthermore, a depression 62, such as an annular groove, can be used in conjunction with the protrusion 60. If the protrusion 60 is placed in the covering 52, then the depression 62 can be placed in the body 12 of the relief valve 10 to catch the protrusion 60 and help secure the covering 52. Similarly, if the protrusion 60 is placed in the valve body 12, then the depression 62 can be placed in the covering 52.

As an alternate mechanism to secure the impact surface 54 until refrigerant exits the relief valve 10, an adhesive can be used. The adhesive can be used between the sleeve 56 and valve body 12. Otherwise, the covering 52 can be a form of tape or a patch, for instance, covering the rear outlet path and adhering only to the surface of the outlet end 18 that faces the impact surface 54.

FIGS. 6 and 7 illustrate an alternate indicator, used in conjunction with a side-vented pressure relief valve 10. A covering 72 is a ring, a sleeve, or a band encircling the valve body 12 in order to cover the side outlet passages 42. It can fit tightly or snuggly to the valve body 12 so it does not slide off its position over the side outlet passages 42 when side outlet passage 42 is dormant. Further, the ring can be held in place using a protrusion, a depression, an adhesive, or another known fastening means that will prevent it from sliding in the axial direction, but not prevent it from tearing off, blowing off, or lifting and shifting axially. The covering 72 gains stability in its positioning from being a full 360 degree ring. However, the covering 72 can merely extend around a portion of the circumference of the valve body 72, or it can merely cover the side outlet passages 42 and no more. When the covering 72 does not extend around at least half the circumference of the valve body 12, then an adhesive or other fastening means might be necessary to temporarily secure the covering 72 from moving in the radial direction.

When the pressure relief valve 10 releases refrigerant through the side outlet passages 42, as illustrated in FIG. 7, then the refrigerant exerts a force on the covering 52. At least the portion of the covering 52 that is positioned directly in the path of the exiting refrigerant over each of the side outlet passageways 72 is moved or damaged. The movement of the covering 52, or damage to it, indicates to a person that the relief valve 10 has been set off. For example, if the covering 52 encircles more than half the valve body 12, then the covering 52 can tear, bend, or flex to be blown off the relief valve 10. The refrigerant can merely blow a hole through the covering 52 at the side outlet port, or it can blow off a larger portion of the covering 52. It can also expand radially, or lift from the surface of the valve body 12 and shift axially, toward or away from the inlet end 14. A marker can be used to help a person discern the shift. If the covering encircles less than half the valve body 12, then the refrigerant can tear, bend, and/or blow the covering off the valve body 12.

FIGS. 8 and 9 illustrate another alternate indicator used in conjunction with a side-vented pressure relief valve 10. Covering 82 is a ring, a sleeve, or a band, encircling the valve body 12 in order to cover the side outlet passages 42. The covering 82 is tapered from its end nearest the inlet end 14 to its opposing end, so that refrigerant exiting each side outlet passage 42 impacts the covering 82 and imparts an axial force as well as a radial force. The axial force causes the covering 82 to shift axially, thereby indicating that the relief valve 10 has released refrigerant, as depicted in FIG. 9.

A ramp 84 can be positioned between the valve body 12 and the covering 82 in order to support the covering 82 and help secure the covering 82 while the side outlet passage remains dormant. The ramp 84 also helps guide the covering 82 when the covering 82 is displaced axially.

Both the covering 82 and the ramp 84 can encircle less than the full circumference of the valve body 12. The covering 82 can be secured radially to the valve body 12 by encircling it around a portion of the valve body 12 substantially more than half the circumference. Alternately, and particularly if the covering 82 encircles less than half the circumference of the valve body 12, then the ramp 84 can be connected to the valve body 12, and the covering 82 can be slidably connected to the ramp 84. Being slidably connected means the covering 82 is held in place through some interaction between features of the ramp 84 and covering 82 until refrigerant is released, after which time the connection is at least partially loosened so the covering 82 can slide along the ramp 84 axial to the elongate direction of the valve body 12. For instance, the ramp 84 might contain rails to which the covering 84 slidably connects so that the covering 84 can slide but can not lift off from the valve body 12. The rails 84 might narrow or otherwise provide more tension on the covering 82 to hold it in place, as the covering 82 slides into position. Again, a protrusion, possibly in combination with a depression, might suffice to secure the covering 82 in position until refrigerant is released.

In each of the embodiments depicted in FIGS. 4-9, the covering 52, 72, 82 can be a variety of materials. For instance, metal, rubber, plastic, paper, gel, and grease or another viscous substance are each suitable. Stronger materials, such as light metals and plastic are better suited for embodiments in which the covering does not tear, but rather indicates refrigerant release by moving. Less sturdy materials, such as paper are better suited for embodiments that indicate refrigerant release by tearing of the covering 54, 72, 82, or being otherwise damaged. Gel or grease is better suited to merely cover the outlet passages 20, 42 and to indicate refrigerant release by being blown off the outlet passages 20, 42. Gel or grease are relatively easy and inexpensive to implement as a covering 52. Elastic materials, such as rubber, can be beneficial in embodiments that indicate the release of refrigerant by moving in a direction non parallel to the direction of the refrigerant flow. For instance, as refrigerant exits the side-vented pressure relief valve 10, it can push between the surface of the covering 52, 72, 82 and the valve body 12. The covering 52, 72, 82 can expand radially, thereby lessening friction or another force securing it in place, after which the covering 52, 72, 82 can more easily be displaced axially. Keeping the material light in weight eases the task of refrigerant exiting the pressure relief valve 10 to move the covering 52, 72, 82.

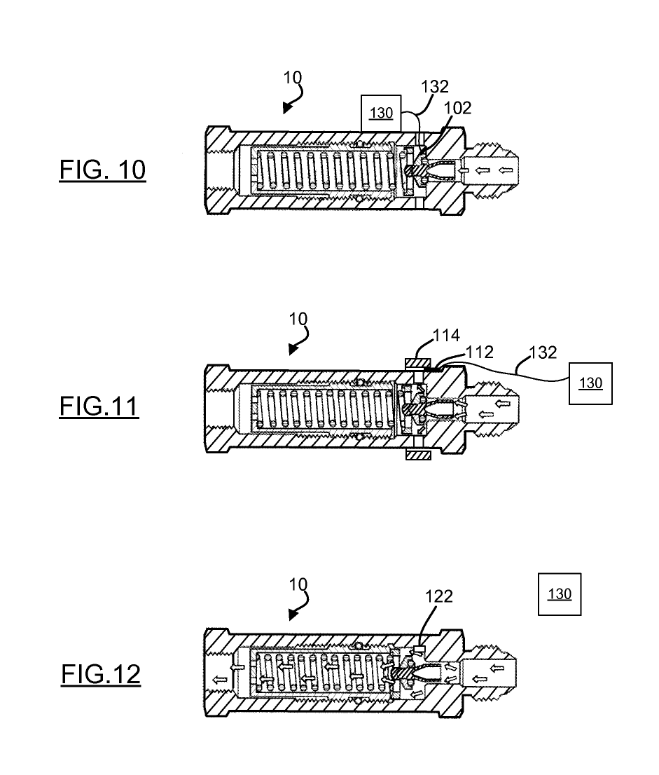

In conjunction with the pressure relief valves illustrated in FIGS. 1-3, FIGS. 10-12 illustrate electrical embodiments of the activation indicator utilizing sensors. Referring first to FIG. 10, an electrical contact 102 attaches between the valve head 28 and an internal surface of the valve body 12. The electrical contact 112 can be thin to connect between two otherwise mating surfaces, or it can extend between two non-mating surfaces. When refrigerant pressure compresses the spring 26, the electrical contact 102 breaks, interrupting the signal. The electrical contact 102 can be connected by wires 132 to a notification device 130, including but not limited to a computer, a controller, a display, or some form of sensory indicator, such as a light or audio generator, such that when the electrical contact 102 is disrupted, the notification device 130 is activated to indicate to a person that the pressure relief device 10 has released refrigerant. Alternatively, the electrical contact 102 can be positioned to other surfaces, as long as one of the surfaces moves during activation of the pressure relief device. For instance, the electrical contact 102 can be positioned between two surfaces on the spring 26, or from the spring 26 to a point on the valve body 12.

Furthermore, the electrical connection can be broken without breaking the electrical contact 102 so that the electrical connection resumes after the pressure relief valve 10 reseals. Breaking the electrical contact 102 is beneficial for generating a continuous indication that the pressure relief valve 10 has been activated, while breaking merely the electrical connection so it can be re-established is beneficial for deactivating the notification device 130 once the pressure relief valve 10 reseals. However, a logic circuit or controller can be configured to continue the activation indication even after the pressure relief valve 10 reseals, until the pressure relief valve 10 is checked by an operator to make sure it resealed properly.

FIG. 11 illustrates the use of a strain gauge or similar sensor mounted on a covering 114 as described with respect to FIGS. 4-9. Any of the covering embodiments can be used, although FIG. 11 illustrates a side-vented pressure relief valve 10 and an elastic band as the covering 114. With this embodiment, refrigerant escapes from the outlet passages 20, 42 to elastically displace the covering 114. Before this displacement, the strain gauge 112 generates an electrical signal whose electrical characteristics vary with the shape of the strain gauge 112. During the displacement, when the covering 114 is displaced, the adjacent or connected strain gauge 112 is bent or flexed, causing the transmitted signal generated by the strain gauge 112 to alter.

The strain gauge 112 can be attached to the pressure relief valve 10 without using the covering 114, so that at least part of the strain gauge 112 is in the flow path and will be flexed during activation of the pressure relief valve 10. However, the covering 114 attaches to the otherwise loose end of the strain gauge 112 to help keep the strain gauge 112 from flexing before activation of the pressure relief valve 10. Alternatively, the strain gauge 112 or other similar sensor can be attached on the spring 26 or another moving part, so that when the spring 26 is compressed by refrigerant pressure, the strain gauge 112 bends or flexes, causing an alteration in the electrical signal it generates.

The strain gauge 112 can be in signal communication with a notification device 130, either directly, such as by means of wires 132, or indirectly through a logic circuit or processor (not shown). The notification device 130 can include, but is not limited to a computer, a controller, a display, or some other device capable of functioning as a sensory indicator, such as a light or audio generator. When the strain gauge 112 alters its transmitted signal, the notification device 130 is activated to indicate to a person that the pressure relief device 10 has released refrigerant.

FIG. 12 illustrates the use of a pressure sensing device 122 mounted in the flow path of refrigerant exiting the pressure relief valve 10. The pressure sensing device 122 is preferably mounted at a point in the flow path where the pressure during refrigerant flow is relatively high, such as close to the inlet passage 16 as shown in FIG. 12 or at a point where the flow path narrows. One such point of narrowing can be at one of the side outlet passages 42 or rear outlet passage 20. However, depending on the sensitivity of the pressure sensing device 122, and the minimum pressure of detection, any point in the flow path can be an acceptable location to mount the pressure sensing device 122.

As with the embodiments described with respect to FIGS. 10 and 11, the pressure sensing device 122 can be in direct or indirect signal communication with a notification device 130, including but not limited to a computer, a controller, a display, or some form of sensory indicator, such as a light or audio generator, such that when the pressure sensing device 122 alters its transmitted signal, the notification device 130 is activated to indicate to a person that the pressure relief device 10 has released refrigerant. Furthermore, each of the embodiments described with respect to FIGS. 10-12 can be in signal communication with the notification device 130 by means of electrical wires, optical fibers, or another electromagnetic medium, such as radio waves. Though the FIGS. illustrate each sensor 102, 112, 122 in direct signal communication with the notification device 130, the signal generated by each sensor 102, 112, 122 can be indirectly communicated to the notification device. For example, the signal generated by each sensor can be processed, or received and retransmitted by a processor or other logic circuitry (not shown). Also, each sensor 102, 112, 122 can be powered by known methods, such as but not limited to batteries or an AC power source (not shown).

While the present invention has been particularly shown and described with reference to certain exemplary embodiments, it will be understood by one skilled in the art that various changes in detail may be effected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements.

We claim:

1. A pressure relief valve activation indicator comprising:
a covering disposed over at least a portion of a pressure relief valve outlet passage, at least a portion of said covering displaceable by refrigerant flowing out said outlet passage so as to indicate said refrigerant has flowed out said outlet passage when said covering is displaced.

2. The pressure relief valve activation indicator as recited in claim 1, wherein said covering comprises a band encircling at least a portion of said pressure relief valve, said band having a refrigerant impact surface disposed over said outlet passage.

3. The pressure relief valve activation indicator as recited in claim 1, wherein a temporary securing mechanism holds said covering in place over said outlet passage until said pressure relief valve is activated.

4. The pressure relief valve activation indicator as recited in claim 1, wherein a semi-permanent securing mechanism holds at least a portion of said covering in place over said outlet passage during activation of said pressure relief valve.

5. The pressure relief valve activation indicator as recited in claim 1, wherein said covering has a surface impacted by said refrigerant, said surface being angled non-perpendicularly to the direction of refrigerant flow out said outlet passage, so as to provide a force to move said band in at least a direction along an axis of said pressure relief valve.

6. The pressure relief valve activation indicator as recited in claim 1, wherein said pressure relief valve includes a marking on an outer surface to enable a person to discern displacement of said covering.

7. The pressure relief valve activation indicator as recited in claim 1, wherein said covering is one from the group consisting of a tape, a boot, a sleeve, a gel, a grease, a viscous substance, a patch, and a cap.

8. The pressure relief valve activation indicator as recited in claim 1, further comprising a ramp on an outer surface of said pressure relief valve, said ramp configured to support said covering.

9. The pressure relief valve activation indicator as recited in claim 1, wherein said displaceable portion remains displaced after said refrigerant stops flowing out said outlet passage.

10. The pressure relief valve activation indicator as recited in claim 1, said indicator further comprising a strain gauge connected to said covering so as to flex when refrigerant exits said pressure relief valve.

11. A method of indicating the activation of a pressure relief valve, the method comprising:
covering at least a portion of an outlet passage of a pressure relief valve with a covering; and
displacing at least a portion of said covering with a refrigerant flowing out of said outlet passage.

12. The pressure relief valve activation indicator as recited in claim 11, wherein a temporary securing mechanism holds said covering in place over said outlet passage until said pressure relief valve is activated.

13. The method as recited in claim 11, wherein said surface is angled so as to provide a force to move said band in a direction along an axis of said pressure relief valve.

14. A pressure relief valve activation indicator comprising:
a pressure relief valve including at least one outlet passage; and
a sensor attached to a component of said pressure relief valve, said sensor transmitting a signal that alters when said pressure relief valve is activated; and
a notification device in electromagnetic communication with said sensor that activates when said transmitted signal is altered.

15. The pressure relief valve activation indicator as recited in claim 14, wherein said sensor is a strain gauge mounted to an outside surface of said pressure relief device.

16. The pressure relief valve activation indicator as recited in claim 15, said indicator further comprising a covering at least partially covering said outlet passage and connecting to said sensor.

17. The pressure relief valve activation indicator as recited in claim 14, wherein said sensor is an electrical contact connecting between two surfaces internal to said pressure relief valve that are moveable in relation to each other.

18. The pressure relief valve activation indicator as recited in claim 14, wherein said sensor is a pressure sensing device positioned internal to said pressure relief valve.

19. A method of indicating the activation of a pressure relief valve, the method comprising:
providing a pressure relief valve;
attaching a sensor in signal communication with a notification device to a first component of said pressure relief valve;
activating said pressure relief valve;
altering a signal transmitted by said sensor; and
activating said notification device.

20. The method of indicating the activation of a pressure relief valve wherein said sensor is an electrical contact connected between said first component of said pressure relief valve and a second component of said pressure relief valve, said second component moving with respect to said first component during activation of said pressure relief valve.

21. The method of indicating the activation of a pressure relief valve wherein said sensor is a pressure sensing device positioned in the flow path of a refrigerant in said pressure relief valve.

22. The method of indicating the activation of a pressure relief valve wherein said sensor is a strain gauge positioned to be flexed during activation of said pressure relief valve.
